(19) United States
(12) Patent Application Publication
(10) Pub. No.: US 2010/0214050 A1
(43) Pub. Date: Aug. 26, 2010

(54) Self-leaded surface mount inductors and methods

(76) Inventors: Gil Opina, JR., Singapore (SG); John Vidallon, Singapore (SG); Hoi Yean Lim, Singapore (SG); James Douglas Lint, Cardiff, CA (US)

Correspondence Address: GAZDZINSKI & ASSOCIATES, PC, 16644 WEST BERNARDO DRIVE, SUITE 201, SAN DIEGO, CA, 92127, US

(21) Appl. No.: 12/229,676

(22) Filed: Aug. 25, 2008

Related U.S. Application Data
(63) Continuation of application No. 12/012,157, filed on Jan. 30, 2008, now abandoned.
Application No. 12/012,157 is a continuation of application No. 11/827,861, filed on Jul. 12, 2007, now abandoned.
(60) Provisional application No. 60/831,059, filed on Jul. 14, 2006.

(51) Int. Cl. H01F 27/29; H01F 27/28; H01F 41/02

(52) U.S. Cl. 336/192; 336/222; 29/606

(57) ABSTRACT

A low cost, high performance inductive device for use in, e.g. electronic circuits is disclosed. In one exemplary embodiment, the device includes a two-legged magnetically permeable core optimized for fitting with one or more windings. Preferably, the device is also self-leaded, thereby simplifying its installation and mating to a parent device (e.g., PCB). In another embodiment, one or more low profile magnetically permeable cores are mounted on a surface of the self-leaded magnetically permeable core, preferably with a gap. In yet another embodiment, the aforementioned gap is obviated. In yet another embodiment, spacers are positioned on a surface of the self-leaded magnetically permeable core device to position the low profile magnetically permeable at a predetermined distance from the self-leaded magnetically permeable core. In yet another embodiment, a bead inductor is disclosed comprising a plurality of turns. Methods for manufacturing and utilizing the devices are also disclosed.

### PRIORITY

This application claims priority to U.S. Provisional Patent Application Ser. No. 60/831,059 filed Jul. 14, 2006 of the same title, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to inductive circuit elements and more particularly to inductive devices having various desirable electrical and/or mechanical properties, and methods of operating and manufacturing the same.

### DESCRIPTION OF RELATED TECHNOLOGY

Myriad different configurations of inductors and inductive devices are known in the prior art. For example, these prior art approaches are exemplified in U.S. Pat. No. 3,585,553 to Muckelroy, et al. issued Jun. 15, 1971 and entitled “Microminiature Leadless Inductance Element” discloses a leadless inductance element. The element comprises a nonconductive core adapted to receive a wire winding and having first and second flanges located at the terminal portions of the core to confine the wire winding to the core. The end face of each of the flanges is flattened and an electrically conductive coating is applied to provide electrical contact with the substrate. A groove is located in each of the flanges and is adapted to receive the terminal portions of the wire winding. Finally an electrically conductive path connects the terminal portions of the wire winding with the flattened electrical contacts at the two flanges.

U.S. Pat. No. 3,745,500 to Simon issued Jul. 10, 1973 and entitled “Flat Wound Coils” discloses a flat wound coil is provided having a hollow rectangular plastic spool with a transverse flange at one end and a transverse head at the other end, said head having two spaced pockets receiving the coil ends and the ends of lead wires with the lead wires extending through passages in the head and an outer heat sealed shell enclosing the coil and pockets.

U.S. Pat. No. 4,704,592 to Marth, et al. issued Nov. 3, 1987 and entitled “Chip inductor electronic component” discloses an electronic component such as a chip inductor having a solid core portion of the ferromagnetic or electrically nonconducting material, with a winding space to be wound in one or more courses and recessed relative to parallel end faces of the core portion. The end faces have dovetail-shaped cutouts located within the outside portion of these end faces for receiving tab-like electric contact elements. These electrical contacts may be glued or wedged into these cutouts and retained therein under the action of resilient properties of the cutout elements.

U.S. Pat. No. 5,212,345 to Gutierrez issued on May 18, 1993 and entitled “Self leaded surface mounted coplanar header” discloses a self leaded header for surface mounting of a circuit element to a PC board comprises a generally box-like support body having a cavity for mounting a circuit element, the support body having a base and a plurality of feet extending downward from the base for supporting the same on a PC board, a plurality of lead support members having a generally spool configuration extending generally horizontally outward from the support body adjacent the base, an inductance coil mounted in the cavity, and a lead extending from the coil to and wound multiple turns around each of the lead support members and disposed for surface bonding to a PC board.

U.S. Pat. No. 5,309,130 to Lint issued May 3, 1994 and entitled “Self leaded surface mount coil lead form” discloses a self leaded holder for surface mounting of a circuit element to a PC board comprises a generally box-like support body having a cavity for mounting a circuit element, the support body having a base and a plurality of lead support members having a generally spool configuration extending generally horizontally outward from the support body adjacent the base, lead ports extending from the cavity through the sides, an inductance coil mounted in the cavity, and a lead extending from the coil via the lead ports to and wound a partial turn around each of the lead support members and disposed for surface bonding to a PC board.

U.S. Pat. No. 5,351,167 to Wai, et al. issued on Sep. 27, 1994 and entitled “Self-leaded surface mounted rod inductor” discloses an electronic component adapted for surface mounting on a PC board that has an elongate bobbin made of a dielectric material. A coil of wire is wound about the winding support surface of the bobbin. The coil has a pair of lead terminations which are wrapped around a pair of T-shaped lead termination support members extending from the same side of the bobbin. When the bobbin rests on top of a PC board, the support members position the wrapped lead terminations slightly above solder pads.

U.S. Pat. No. 5,760,669 to Dangler, et al. issued Jun. 2, 1998 and entitled “Low profile inductor/transformer component” discloses a low profile, low cost, high performance inductor/transformer component having a wire coil within a core set which is disposed at least partially within a recess in a header. The header includes projections extending from it which form terminals when wire leads from the coil are wrapped around them.

U.S. Pat. No. 5,867,891 to Lampe, Jr., et al. issued Feb. 9, 1999 and entitled “Continuous method of manufacturing wire wound inductors and wire wound inductors thereby” discloses a wire-wound inductor that includes a dielectric core, terminals including wire staples that are crimped around the core, and a wire winding disposed about the perimeter of the core and connected to the terminals. A coating such as an adhesive coating is disposed over the wire winding and between the terminals. The process for manufacturing the inductors in a continuous process. Beginning with a spooled material, which may be extruded, inductors are formed on a core material sequentially. The inductors are not physically separated until the final stages of manufacturing, which is in contrast to the prior art method in which each inductor is individually constructed on an individual core that has been manufactured with tight tolerances and wound individually. By virtue of the characteristics of the inductor components, extremely tight tolerances (typically about 0.0005″) can be obtained, resulting in highly controlled inductance values.

U.S. Pat. No. 5,933,949 to Lampe, Jr., et al. issued Aug. 10, 1999 and entitled “Surface mount device terminal forming apparatus and method” discloses terminals for a surface mount device that are crimped about the device core in a staple-like manner, utilizing spooled wire as the terminal filament. The spooled wire is supported above the core material in a mechanical platform, and first and second slide assemblies shape the conductive filament about the upper perimeter of the core material and the underside of the core material, respectively. The simplified process reduces manufacturing time and costs.

U.S. Pat. No. 6,005,465 to Kronenberg, et al. issued on Dec. 21, 1999 and entitled “Coil assembly and method for contacting the coil on a support body” discloses a coil assembly that has a coil form on which the coil winding is arranged as well as a method of contacting the coil assembly on a support member. The coil assembly is easy to produce and also permits electrical contacting, namely, the provision of electrical contacts between terminals of the coil and an external circuit in a simple and reliable manner. The coil assembly has a coil form on which two contact feet are arranged, the ends of the coil winding being fastened to the respective contact feet.

U.S. Pat. No. 6,005,467 to Abramov issued Dec. 21, 1999 entitled “Trimmable inductor” discloses a trimmable inductor comprising a supporting substrate having spaced apart lead terminals, a coil defined by an electrically conductive member mounted on the substrate in a continuous path of multiple turns forming a winding about an axis and extending between the lead terminals, and an electric conductive shorting member extending and electrically connected between one or more turns and a terminal of the coil to enable selective inclusion and elimination of at least part of one of the turns of the coil.

U.S. Pat. No. 6,018,285 to Maeda issued Jan. 25, 2000 and entitled “Wire-wound component to be mounted on a printed circuit board” discloses a wire-wound component to be mounted on a printed circuit board. The wire-wound component is formed by winding a wire on the body of the wire-wound component and by winding both end portions of the wire on terminals. The terminals and the body of the wire-wound component are formed as one unit by molding same from a heat-resistant resin material. The molded terminals, on which both end portions of the wire are wound, are inserted into the printed circuit board, and then connected to a circuit pattern on the printed circuit board by soldering.

U.S. Pat. No. 6,073,339 to Levin issued Jun. 13, 2000 and entitled “Method of making low profile pin-less planar magnetic devices” discloses a method for making a planar magnetic device. The magnetic device has generally spirally-directed planar coils supported on plural substrates. The plural substrates are stacked so as to have their respective outer peripheries connected to termination pads which are laterally spaced from the termination pads of other coils, as viewed in a direction perpendicular to the planar coils. The inner termini of at least two of the coils may be interconnected by a plated via to constitute a single winding on plural planes. An exposed portion of the termination pads resides alongside vertical edges of the magnetic device and is electrically connected to vertical plating which form pin-less terminations of the magnetic device. The magnetic device may include a beveled portion for orientation of the device in a circuit. A method of manufacturing the magnetic device is also disclosed.

U.S. Pat. No. 6,081,180 to Fernandez, et al. issued Jun. 27, 2000 and entitled “Toroid coil holder with removable top” discloses a housing for a toroid coil that has side walls closely formed around the coil and a top connected at a gap from the side walls by attachments. The top provides a flat, relatively smooth vacuum pick up surface for mounting the coil on a circuit board and is removable by breaking off the attachments. The side walls have a front wall with wire wrap posts extending therefrom positioned so that the wire of the coil lies in the mounting plane for surface mount connection when wrapped on the posts. Slots are provided in the front wall to receive the wire to prevent cutting or scoring of the wire or its coating or cover during removal of the top. The back of the walls is open to reduce length and thickened supports are provided at the edges of the walls adjacent the back.

U.S. Pat. No. 6,087,920 to Abramov issued Jul. 11, 2000 entitled “Monolithic inductor” discloses a monolithic inductor comprising an elongated substrate having opposite distal ends and, each end having an end cap extending from the opposite ends to support the substrate in spaced relation from a PC board, the end caps being formed with non-mounting areas and a deflection area for preventing the substrate resting on the non-mounting area, a substantially steep side wall on the substrate side of the end cap at the non-mounting area, and an inclined ramp extending up to a top of the end cap on the substrate side substantially opposite the non-mounting area, an electrically conductive soldering band extending partially around each end cap, each soldering band having a gap at the non-mounting area for thereby reducing parasitic conduction in the band, and an electrically conductive layer formed on the substrate in a helical path extending between the opposite ends and in electrical contact with the conductive soldering bands at the ramps.

U.S. Pat. No. 6,087,921 to Morrison issued Jul. 11, 2000 and entitled “Placement insensitive monolithic inductor and method of manufacturing same” discloses a monolithic inductor that comprises an elongated substrate having opposite distal ends and, each end having an end cap extending radially from the respective end to support the substrate in spaced relation from a PC board, each end cap having a plurality of intersecting planar surfaces defining corners, an electrically conductive layer forming a winding on the substrate and extending between the opposite ends to provide a winding, and an electrically conductive soldering pad extending partially around at least some of the corners of said end caps at each end of the substrate in electrical contact with the conductive layer, each soldering pad providing a terminal on each of the intersecting planar surfaces.

U.S. Pat. No. 6,157,283 to Tsunemi issued Dec. 5, 2000 and entitled “Surface-mounting-type coil component” discloses a surface-mounting-type coil component, for mounting on a hybrid IC such as a DC-DC converter, is provided. Such a surface-mounting-type component comprises a core having a flat core portion in which the ratio of thickness to width (t/w) is not greater than 1/3, flange portions extending from both ends of the core portion in a longitudinal direction to be integrated with the core portion, two or four electrode layers spacedly positioned apart from each other and formed on peripheral portions, including side surfaces of the flange portions in at least a vertical direction, of the flange portions of the core, and a winding wound on the core portion of the core, having both ends obliquely led from the side surfaces of the flange portions and conductively fixed to the electrode layers of the side surfaces by thermo-compression bonding.

U.S. Pat. No. 6,373,366 to Sato, et al. issued Apr. 16, 2002 and entitled “Common mode filter” discloses a common mode filter that includes a drum-shaped core with a winding and a plate-like core fixed to flanges to form a closed magnetic path. Concave portions are formed in at least one of the facing portions of both cores to provide gaps between the flanges of the drum-shaped core and the plate-like core. A plurality of electrodes each of which is successive over an upper surface, end face and lower surface of each flange are provided at portions corresponding to the gaps in each flange. A plurality of windings are wound around the winding core so that both ends of each of the plurality of windings are electrically connected and secured to the portions of the electrodes on the upper surface of each of the flanges, respectively, by conductive fixing agent. The drum-shaped core and the plate-like core are fixed to each other by an adhesive.

U.S. Pat. No. 6,570,478 to Meeks issued May 27, 2003 and entitled “Surface mounted low profile inductor” discloses a low profile surface mountable toroid inductor. The apparatus features a one step molded housing which includes a cover and opposing mounting legs. The housing is molded in a liquid crystal polymer. The length of wire that provides the turns on the toroid also serves as the mounting pads as each end of the wire that is left exposed during the housing molding process is then wrapped around its corresponding leg to provide a mounting pad. The apparatus is able to achieve a thickness that is less or equal to 1.5 mm by eliminating the thickness of a prefabricated cover. Further, a flat surface can be molding into the housing so that the apparatus can be positioned with “pick and place” techniques. Also, the apparatus can be configured so that it can be mounted upside down as well. A blind hole is provided that orients the toroid within the mold and serves to prevent any gate vestige from protruding beyond the mounting surface as well as reducing mechanical stress on the press due to the different coefficients of thermal expansion of the respective components.

U.S. Pat. No. 6,573,820 to Yamada, et al. issued Jun. 3, 2003 and entitled “Inductor” discloses an inductor that is obtained by forming conductors of a desired shape on bendable plate type support members, providing a slit in one end of each of the conductors, and a claw on the other end of each of the conductors, bending the plate type support members, engaging the slits and claws with each other so as to form windings on the support members and openings therein, and inserting magnetic cores through the openings.

U.S. Pat. No. 6,717,500 to Girbachi, et al. issued Apr. 6, 2004 and entitled “Surface mountable electronic component” discloses a low profile electronic component in accordance with the invention that includes an elongated core made from a magnetic material such as ferrite, which is connected to a base having a plurality of metalized pads attached thereto for electrically and mechanically connecting the component to a printed circuit board. Support structures or spacers are positioned at the ends of the core and are provided to assist the core in shielding the component and concentrating its magnetic lines of flux. The component also includes a winding of wire wound about at least a portion of the base and core assembly between the supports, and has the ends of the wire electrically and mechanically connected to the metalized pads of the base. A top portion may be coupled to the core via the supports to cover at least a portion of the windings of wire of the component. The supports separate the core and the top portion and maintain the top portion at a desired position with respect to the winding and the core. The core supports, and top portion provide a source of additional shielding for the component and improve the performance of the overall component by concentrating the lines of flux emitted by the component thereby increasing the flux density of the component and its inductance.

U.S. Pat. No. 6,778,055 to Wang issued Aug. 17, 2004 and entitled “Core member for winding” discloses a core member for winding having a main body and two end flanges at two ends of the main body, each end flange having a top step above the elevation of the topmost edge of the main body and two upright legs vertically upwardly protruded from the step in an offset position.

U.S. Pat. No. 6,788,179 to Holler, et al. issued Sep. 7, 2004 and entitled “Inductive miniature component for SMD-mounting and method for the production thereof” discloses an inductive miniature component for SMD-mounting with a coil support (1) formed of synthetic or ferrite material, in or on which is arranged at least one coil winding, whereby outwardly projecting connection pegs (1.1) are arranged on an outer side of the coil support and formed therewith as a single piece, each connection peg having several turns of an end (2.1) of a respective winding wire of a coil wire wound there around. A metallic wire winding (3.1) is disposed between the outer surface of the connection peg (1.1) and the winding wires (2.1), the metallic wire winding being comprised of an electrically conducting wire whose diameter is greater than the diameter of the winding wire and several turns of the metallic wire winding being directly wound on the connection peg (1.1).

U.S. Pat. No. 6,897,753 to Dixon issued May 24, 2005 and entitled “Housing for a transformer” discloses a housing for a transformer. According to one embodiment, the housing includes a top portion, and first, second, third and fourth side portions connected to the top portion. The side portions define an opening. The third side portion includes a first alignment tab and the fourth side portion includes a second alignment tab. The housing also includes first, second, third and fourth termination legs. The first and second termination legs are proximate the third side portion, and the third and fourth termination legs proximate the fourth side portion. A transformer may be disposed in the opening defined by the side portions of the housing.

U.S. Pat. No. 6,919,788 to Holdahl, et al. issued Jul. 19, 2005 and entitled “Low profile high current multiple gap inductor assembly” discloses an inductor assembly that includes a coil or coils of insulated conductor material defining an inside volume, an inner core of magnetic core material located within the inside volume, and an outer core of magnetic core material including structure overlying the coil and inner core and having opposite inner walls facing polar ends of the coil and core, such that at least two magnetic gaps exist between ends of the inner core and the opposite inner walls of the outer core. A method for making the assembly is also disclosed.

U.S. Pat. No. 7,002,074 to Settergren, et al. issued Feb. 21, 2006 and entitled “Self-leaded surface mount component holder” discloses a self-leaded, surface mountable component package for holding a wide variety of electrical components having widely variant conductor wire sizes in a manner achieving standardized conductor contact positioning. The general box-like configuration provides for component style variability and has a set of progressively stepped or tapered winding bosses to position and secure component conductors of multiple wire size, thereby ensuring proper registration with conductive traces of surface mount printed circuit boards and substrates.

U.S. Pat. No. 7,009,482 to Kiko, et al. issued Mar. 7, 2006 and entitled “Controlled inductance device and method” discloses improved inductive apparatus having controlled core saturation which provides a desired inductance characteristic with low cost of manufacturing. In one embodiment, a pot core having a variable geometry gap is provided. The variable geometry gap allows for a “stepped” inductance profile with high inductance at low dc currents, and a lower inductance at higher dc currents, corresponding for example to the on-hook and off-hook states of a Caller ID function in a typical telecommunications line. In other embodiments, single- and multi-spool drum core devices are disclosed which use a controlled saturation element to allow for selectively controlled saturation of the core. Exemplary signal conditioning circuits (e.g., dynamically controlled low-capacitance DSL filters) using the aforementioned inductive devices are disclosed, as well as cost-efficient methods of manufacturing the inductive devices.

U.S. Pat. No. 7,009,484 to Gray, et al. issued Mar. 7, 2006 and entitled “Magnetic assembly” discloses a magnetic assembly for mounting to a circuit that includes a winding and a core. The winding has a first end, a second end and a wound portion. Further, the core is disposed around at least a portion of the winding. The first end of the winding extends outward from the wound portion to define a linear support and the second end of the winding extends outward from the wound portion on an opposite side of the wound portion to define a point support. As such, the first and second ends of the winding are adapted to mount to the circuit.

United States Patent Publication No. 20030184423 to Holdahl, et al. published Oct. 2, 2003 and entitled “Low profile high current multiple gap inductor assembly” discloses an inductor assembly that includes a coil or coils of insulated conductor material defining an inside volume, an inner core of magnetic core material located within the inside volume, and an outer core of magnetic core material including structure overlying the coil and inner core and having opposite inner walls facing polar ends of the coil and core, such that at least two magnetic gaps exist between ends of the inner core and the opposite inner walls of the outer core. A method for making the assembly is also disclosed.

United States Patent Publication No. 20030184948 to Settergren, et al. published Oct. 2, 2003 and entitled “Self-Leaded Surface Mount Component Holder” discloses a self-leaded, surface mountable component package for holding a wide variety of electrical components having widely variant conductor wire sizes in a manner achieving standardized conductor contact positioning. The general box-like configuration provides for component style variability and has a set of progressively stepped or tapered winding bosses to position and secure component conductors of multiple wire size, thereby ensuring proper registration with conductive traces of surface mount printed circuit boards and substrates.

United States Patent Publication No. 20040135660 to Holdahl, et al. published Jul. 15, 2004 and entitled “Low profile high current multiple gap inductor assembly” discloses an inductor assembly that includes a coil or coils of insulated conductor material defining an inside volume, an inner core of magnetic core material located within the inside volume, and an outer core of magnetic core material including structure overlying the coil and inner core and having opposite inner walls facing polar ends of the coil and core, such that at least two magnetic gaps exist between ends of the inner core and the opposite inner walls of the outer core. A method for making the assembly is also disclosed.

United States Patent Publication No. 20050046534 to Gilmartin, et al. published Mar. 3, 2005 and entitled “Form-less electronic device and methods of manufacturing” discloses a form less electronic apparatus and methods for manufacturing the same. In one exemplary embodiment, the apparatus comprises a shape-core inductive device having a bonded-wire coil which is formed and maintained within the device without resort to a bobbin or other form(er). The absence of the bobbin simplifies the manufacture of the device, reduces its cost, and allows it to be made more compact (or alternatively additional functionality to be disposed therein). One variant utilizes a termination header for mating to a PCB or other assembly, while another totally avoids the use of the header by directly mating to the PCB. Multi-core variants and methods of manufacturing are also disclosed.

United States Patent Publication No. 20050151614 to Dadafshar, published on Jul. 14, 2005 and entitled “Inductive devices and methods” discloses a low cost, low profile and high performance inductive device for use in, e.g., electronic circuits. In one exemplary embodiment, the device includes a four-legged ferrite core optimized for fitting with four or more windings, thereby providing four close-tolerance inductors. Optionally, the device is also self-leaded, thereby simplifying its installation and mating to a parent device (e.g., PCB). In another embodiment, multiple windings per leg are provided. In yet another embodiment, the device has only to opposed legs, thereby reducing footprint. Methods for manufacturing and utilizing the device are also disclosed.

United States Patent Publication No. 20060012457 to Reppe, et al. published on Jan. 19, 2006 and entitled “Transformer or inductor containing a magnetic core having abbreviated sidewalls and an asymmetric center core portion” discloses an inductor or transformer for mounting on a PCB that has a two-part magnetic core structure and at least one coil wound on a bobbin. Each core part has a backwall and an abbreviated outer skirt extending from the backwall and an asymmetric center core element extending from the backwall in the same direction as the outer skirt along a longitudinal axis parallel with the mounting plane and including the centroid of the center core element. The center core element is asymmetric relative to a dividing plane parallel with the mounting plane and including the longitudinal axis, such that a greater portion of the center core element lies on a side of the dividing plane than on an opposite side of the dividing plane. In one preferred form, the center core element has a cross-sectional shape resembling a “D” character turned on its side, or “lazy D” shape.

Despite the foregoing broad variety of prior art inductor configurations, there is a distinct lack of a simplified and low-cost inductor configuration that provides improved performance over prior art devices. What is needed is a minimally sized low cost inductive device and associated methods for use in a variety of electronic applications such as e.g. computer motherboard Voltage Regulator Modules (“VRMs”). Such an improved design would (1) minimize the number of components needed; (2) reduce magnetic flux fringe losses associated with gapped cores; (3) simplify construction to enable automation; and (4) improve the repeatability of the design.

Further, prior art bead inductors lack configurations that incorporate more than one turn while operating within predesignated size and performance (e.g. high current) constraints, and hence an improved solution is required there as well.

### SUMMARY OF THE INVENTION

In a first aspect of the invention, an improved inductive device is disclosed. In one embodiment, the device has multiple turns, and comprises: a magnetically permeable core element; and a plurality of windings disposed about said core element; wherein said core element is adapted for self leading of at least a portion of the plurality of windings for mating to an external device.

In a second aspect of the invention, a method of manufacturing the aforementioned inductive device is disclosed.

In a third aspect of the invention, an electronics assembly and circuit comprising the inductive device is disclosed.

In a fourth aspect of the invention, an improved inductor is disclosed. In one embodiment, the inductor includes multiple turns, and comprises: a conductive winding comprising a plurality of turns; and a plurality of substantially rectangular core elements; wherein at least one of the plurality of core elements is adapted with a substantially diagonal recess, thereby allowing the conductive winding to comprise multiple turns.

In a fifth aspect of the invention, a method of manufacturing the aforementioned inductor is disclosed.

In a sixth aspect of the invention, an electronics assembly and circuit comprising the inductor is disclosed.

In a seventh aspect of the invention, a multiple turn inductive device is disclosed. In one embodiment, the device comprises: a conductive winding comprising a plurality of turns; and a plurality of substantially rectangular core elements. At least one of the plurality of core elements comprises a diagonal recess, thereby allowing the conductive winding to comprise multiple turns.

In another embodiment, the multiple turn inductive device comprises: a conductive winding comprising a plurality of turns and a plurality of solderable edges; a plurality of termination clips; and a plurality of substantially rectangular core elements. At least one of the plurality of core elements comprises a recess, thereby allowing the conductive winding to comprise multiple turns.

In yet another embodiment, the multiple turn inductive device comprises: a magnetically permeable core element; and a plurality of windings disposed about the core element. The core element is adapted for self leading of at least a portion of the plurality of windings for mating to an external device.

In still a further embodiment, the multiple turn inductive device comprises: a unitary magnetically permeable core element comprising at least one spindle element and a plurality of leg elements; and a plurality of windings disposed about the core element. The plurality of leg elements disposed upon the unitary magnetically permeable core element are adapted for self leading of at least a portion of the plurality of windings for mating to an external device.

In an eighth aspect of the invention, a multi-turn inductive device for use in electronics applications is disclosed. In one embodiment, the device comprises: a unitary magnetically permeable core element comprising at least one spindle portion and a plurality of end portions; a substantially planar magnetically permeable cap element, at least one of the plurality of end elements comprising a substantially planar top surface to which the cap element is directly or indirectly mated; and at least one winding comprising a plurality of turns, the plurality of turns being wound about at least the spindle portion of the core element. The plurality of leg elements disposed upon the unitary magnetically permeable core element are shaped so as to permit self-leading of at least a portion of the plurality of turns, the self-leading providing for mating to an external device.

### BRIEF DESCRIPTION OF THE DRAWINGS

The features, objectives, and advantages of the invention will become more apparent from the detailed description set forth below when taken in conjunction with the drawings, wherein:

FIG. 1 is a front perspective view illustrating a first embodiment of a self-leaded inductive device.

FIG. 1a is a side elevational view illustrating the first embodiment of a self-leaded inductive device as shown in FIG. 1.

FIG. 2 is a front perspective view illustrating a second embodiment of a self-leaded inductive device with a gapped “I” core.

FIG. 2a is a front perspective exploded view of the second embodiment of the self-leaded inductive device shown in FIG. 2.

FIG. 3 is a front perspective view illustrating a third embodiment of a self-leaded inductive device with an “I” core and spacers.

FIG. 3a is a front perspective exploded view of the third embodiment of the self-leaded inductive device shown in FIG. 3.

FIG. 4 is a front perspective view of a dual self-leaded inductive device in accordance with the principles of the present invention.

FIG. 4a is a logical flow diagram illustrating one exemplary embodiment of the method for manufacturing the self leaded inductive device of the invention.

FIG. 5a is a front perspective view of a first embodiment of a multi-turn bead inductor in accordance with the principles of the present invention.

FIG. 5b is a reverse perspective view of the first embodiment of a two turn bead inductor of FIG. 5a.

FIG. 6a is a front perspective view of a base core element used in the two turn bead inductor of FIGS. 5a and 5b.

FIG. 6b is a front perspective view of a conductive winding element used in conjunction with the base core element of FIG. 6a.

FIG. 6c is a top view of the conductive winding element shown in FIG. 6b.

FIG. 6d is a reverse perspective view of the conductive winding element shown in FIGS. 6b and 6c mounted in the base core element of FIG. 6a.

FIG. 6e is a front perspective view of the conductive winding element shown in FIGS. 6b and 6c mounted in the base core element of FIG. 6a.

FIG. 6f is a front perspective view showing a first core assembly comprising the conductive winding elements of FIGS. 6b and 6c formed on the base core element of FIG. 6a so that the second core assembly of FIG. 7c may be received.

FIG. 7a is a reverse perspective view of the cap core element used in the two turn bead inductor of FIGS. 5a and 5b.

FIG. 7b is a front perspective view of a termination clip used in conjunction with the cap core element of FIG. 7a.

FIG. 7c is a reverse perspective view of the second core assembly comprising the cap core element of FIG. 7a and termination clip of FIG. 7b.

FIG. 8 is a reverse perspective exploded view of the first core assembly of FIG. 6f and the second core assembly of FIG. 7c.

FIG. 9a is a front perspective view of a dual two-turn bead inductor in accordance with the principles of the present invention.

FIG. 9b is a front perspective view of a bead inductor comprising more than two turns in accordance with the principles of the present invention.

FIG. 10 is a logical flow diagram illustrating one exemplary method for manufacturing the bead inductor of FIGS. 5a and 5b.

### DETAILED DESCRIPTION OF THE PREFERRED EMBODIMENT

Reference is now made to the drawings wherein like numerals refer to like parts throughout.

As used herein, the term “magnetically permeable” refers to any number of materials commonly used for forming inductive cores or similar components, including without limitation various formulations made from ferrite.

As used herein, the term “winding” refers to any type of conductor, irrespective of shape, material, cross-section, insulation or lack thereof, or number of turns, which is adapted to carry electrical current.

### Overview

The present invention provides, inter alia, improved inductive apparatus for use in, e.g., electronics applications, and methods for manufacturing and installing the same.

In the electronics industry, as with many industries, the costs associated with the manufacture of various devices are directly correlated to the costs of the materials, the number of components used in the device and the complexity of the assembly process. Therefore, in a highly cost competitive environment such as the electronics industry, the manufacturer of electronic devices with designs that minimize cost (such as by minimizing the cost factors highlighted above) will maintain a distinct competitive advantage over competing manufacturers.

Many prior art inductive devices utilize a large number of sizes and configurations but often implement designs which utilize at least the following: (1) a polymer bobbin; (2) a magnetically permeable core; (3) magnet or flat coil wire; and (4) metal alloy wire lead terminations. The present invention seeks to minimize costs by combining two or more of the aforementioned components into a single component, thereby reducing the number of components used, the costs of the components used and the complexity of the overall assembly process.

In one exemplary embodiment of the inductive device of the present invention, the aforementioned bobbin, magnetically permeable core and wire lead terminations are effectively combined into a single inductive device apparatus. By combining these components into a single device (and thus permitting these components to be manufactured in a single process), component costs are reduced and performance (including spatial density) is increased. This inductive device will also be configured to be self-leaded, thereby further increasing its spatial density, simplicity, and ease of use, and reducing its cost of manufacturing.

Further, many prior art bead inductors do not effectively implement designs incorporating more than one turn. Another embodiment of the present invention accordingly utilizes a multi-turn (e.g., two turn) bead inductor that operates within desirable size and performance characteristics that are useful in e.g., the power regulation electronics industry.

### Self-Leaded Inductive Core Embodiments

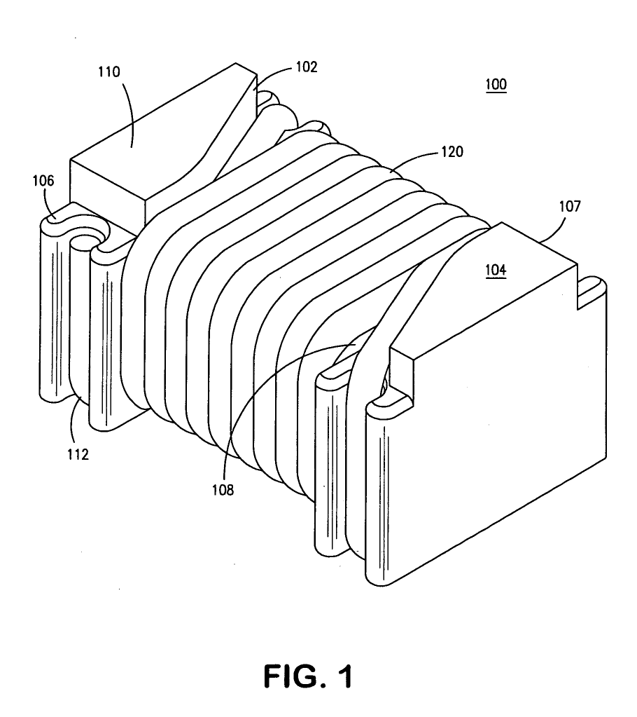

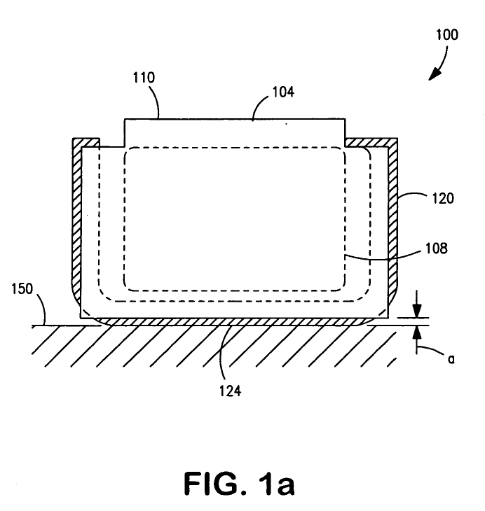

Referring now to FIG. 1, a first exemplary embodiment of the present invention is described in detail. It will be recognized that while the following discussion is cast in terms of an inductor, the invention is equally applicable to other inductive devices (e.g., transformers and the like).

FIG. 1 shows an illustrative embodiment of an inductive device 100 comprising a “common” or unitary core inductor 110. FIG. 1 shows a perspective view of the device 100, which generally comprises a device core 110 comprising a plurality of legs 106, a mating surface 104 and a central spindle element 108. The mating surface 104 generally comprises a substantially planar top face, which can be adapted for use with pick-and-place equipment if desired, adapted for use with other magnetically permeable elements (as will be discussed subsequently herein), or alternatively might not be utilized at all (and hence could be any shape or texture). In addition, the height, cross-sectional area, and profile of the central spindle element 108 and device 100 in general, can be adjusted as desired (discussed in greater detail below) in order to provide the desired electrical properties of the device 100, as well as accommodating various size and shape or form constraints.

The core 110 is, in the illustrated embodiment, either formed directly (e.g. via sintering or comparable methods) as shown, or alternatively machined from a block, so as to have the desired features and shape. Using the latter approach, either alone or in combination with the first approach, a common block can advantageously be used as the basis for multiple different designs having varying shapes and associated electrical properties, and no special (expensive) additional tooling would be required. For example, where a device is designed to have a first cross-sectional area about the spindle element 108, material can be machined off via well known techniques (e.g., milling or grinding) to define a new cross-sectional area. Notwithstanding the foregoing, it will be appreciated that the core of the present invention can feasibly be made to have any number of varying geometries, shapes, contours, etc. consistent with the intended application(s).

Additionally, not only can the size of the center spindle element 108 be varied depending on the application or desired operation of the inductive device, but also may have a different cross-sectional shape (whether uniform or non-uniform in shape or cross-sectional area over the length of the spindle element 108). For example, such cross-section may be circular, elliptical, hexagonal, triangular, etc., as well as being tapered toward one end, “dumbbell” shaped, etc. In this fashion, each inductive device 100 can be specifically adapted for its intended application. In one such exemplary application, finer gauge windings 120 wound about the spindle element 108 might require a circular cross sectioned spindle element 108 to prevent wire breakage during manufacture. In another application, a rectangular cross section may be used to maximize the available cross-sectional area available to the inductive device for a given sized footprint.

A plurality of windings 120 are disposed on the spindle element 108 in the present embodiment. Each end winding of the plurality of windings 120 is disposed in its respective channel 112 of each leg 106 in a wrap-around fashion, such that at least a portion of the windings 120 are disposed proximate to the underside of the device core 110. This approach advantageously allows for self-leading, described below, wherein the bottom portion of the windings 120 comprise, inter alia, mounting points for electrically connecting the device 100 to a parent PCB. As such, the pads 120 may be electrically connected to the parent PCB in any number of ways well known in the art (e.g. solder joints, direct forced physical contact, adhesives, bonding, etc.).

In one embodiment the magnetically permeable material utilized for the device core 110 will comprise a Ni—Zn material. Ni—Zn is known for its good resistive properties allowing for self leaded terminations of the windings 120. The self-leading of wire or other conductive terminations is described in e.g. co-owned U.S. Pat. No. 5,351,167 issued Sep. 27, 1994 the contents of which being incorporated by reference in their entirety herein. Further, the bonding of conductive windings to magnetically permeable materials is discussed in co-owned and co-pending U.S. application Ser. No. 11/231,486 filed Sep. 20, 2005 and entitled “SIMPLIFIED SURFACE-MOUNT DEVICES AND METHODS”, which is incorporated by reference in its entirety herein.

Furthermore, different types of pad and winding structures may be used with the device as is well known in the electronic arts, including without limitation terminal pins, balls, and surface mount (i.e., “Gull wing” shaped) leads. The windings 120 (and hence the pads, which are merely part of the windings 120) are made of electrically conductive materials (e.g., copper or copper alloys), although other materials may be used.

It will further be recognized that the windings 120 and conductive pads may be actually formed onto the core 110 itself, such as for example where the windings are coated or plated onto the surface of the core 110 (not shown), such as within the recesses 112 formed within the legs 106. The conductive windings 120 can also feasibly be sprayed on as well, i.e., as a thin layer of conductive material on the surface of the core 110. Myriad other approaches to providing conductive traces on one or more surfaces of the core 102 may be used consistent with the invention all such variants being readily implemented by those of ordinary skill provided the present disclosure.

Furthermore, it will be appreciated that the various windings may be made heterogeneous in, e.g., inductance, thickness, height, interface configuration (i.e., pin, SMT, etc.), and/or material. Myriad different variations of these different parameters are possible in order to produce a device with the desired qualities.

Each leg 106 will also advantageously comprise a lead-in channel 102 that guides the end of the winding 120 into the leg channel 112. This lead-in channel 102 will facilitate the automation of the winding placement by automated winding equipment.

Referring now to FIG. 1a, the process by which the inductive device 100 attaches itself to a parent printed circuit board 150 is made more apparent. The end termination of the windings 120 wraps itself around channel 112. The depth of channel 112 is shallower than the width of the individual wires in winding 120. This allows the winding immediately adjacent to the parent device 150 to protrude past the bottom of core element 110 a predetermined distance “a”. This protruding wire allows the termination 124 of device 100 to provide a properly filleted solder joint on parent device 150 during soldering operations (e.g. IR reflow, etc.).

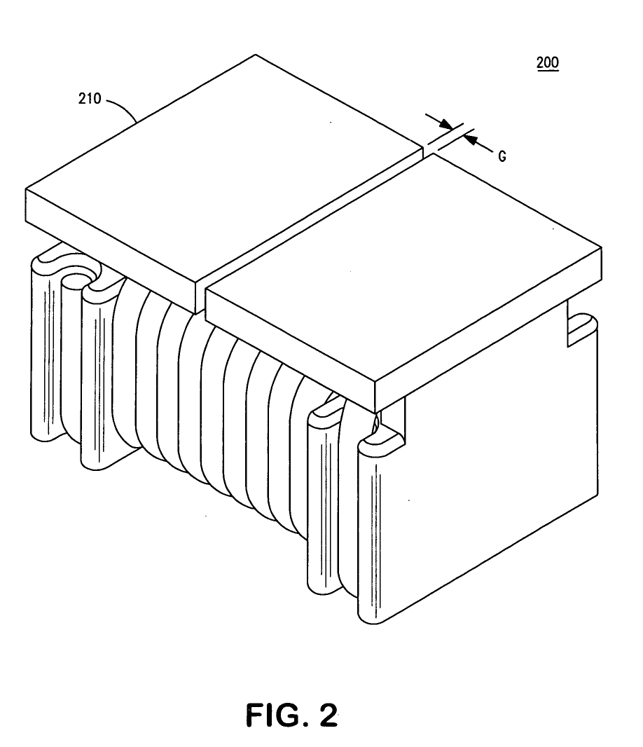

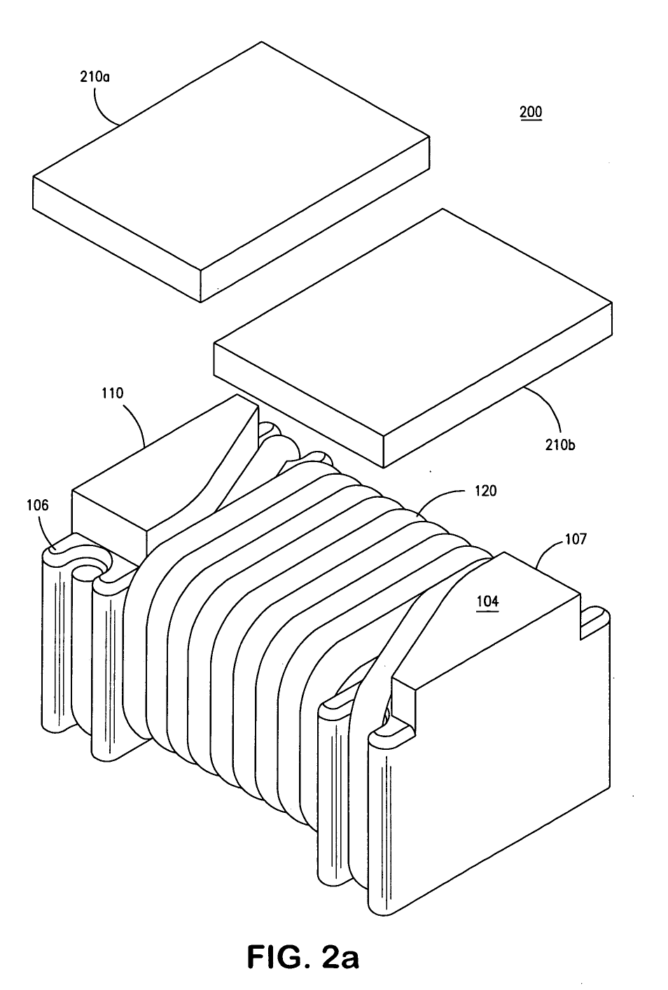

Referring now to FIG. 2, another exemplary embodiment of an inductive device 200 is shown and described in detail. The inductive device 200 of FIG. 2 generally comprises an inductive device similar to that shown in FIG. 1, yet further comprises a pair of magnetically permeable cap cores 210 disposed on the top surface 104 of the core device 110 (FIG. 2a). While presently shown in a configuration where the cap cores 210 are disposed on the top surface, it is contemplated that these cap cores 210 may be disposed on other surfaces (such as the front or back surfaces) with appropriate modifications. In the embodiment shown in FIG. 2, the pair of cap cores 210a, 210b is separated by a predetermined distance having a dimension “G”.

The use of a gap prevents core saturation at higher current levels, as well as adjusting the permeability and inductance effects of the inductive device 200. As is well understood in the electronic arts, the size and geometry of the gap may be varied to achieve a desired electrical performance characteristic. Yet another inherent advantage of the present embodiment is that since only one gap is utilized, fringe losses associated with the gap are minimized. However, more than one gap may be readily implemented when desired.

In alternative embodiments, this gap may be filled with a dielectric compound or other materials to further alter the performance of the inductive device 200. Materials of desired magnetic properties (e.g., permeability) may also be placed within all or a portion of the gap(s), such as where a Kapton (polyamide) layer or the like is interposed between the core members. This layer may also provide an adhesive or structural function; i.e., retaining the various components in a fixed relative position. Myriad other techniques, such as those disclosed by co-owned U.S. Pat. No. 6,642,827 entitled “Advanced electronic microminiature coil and method of manufacture”, which is incorporated by reference herein in its entirety, may be readily employed in the present device 200 as well.

Referring again to FIG. 2a, the cap core elements 210 are ideally formed from identical material to that of the underlying core device 110, which the cap element 210 sits atop when assembled. Heterogeneous material may be used, however, if desired. The caps 210 are substantially planar in the illustrated embodiment, although it can be made in literally any shape including relief on its underside akin to that shown in co-owned and co-pending U.S. patent application Ser. No. 10/990,915 filed Nov. 16, 2004 and entitled “Inductive Devices and Methods”, which is incorporated by reference herein in its entirety. Furthermore, the cap 210 and core 110 can be made such that any desired relationship exists between the relevant portions of the underside of the cap and the (i) central spindle element 108, and (ii) the top surfaces 104 of the risers 107. For example, in one embodiment, the central spindle element 108 supports the cap core 210, with an air gap of desired shape and magnitude being formed between the cap 210 and the individual risers 107. As is well known in the magnetics arts, the size and geometry (and interposed material if any) of the gap controls, inter alia, the magnetic flux density passing through the gap and the leakage inductance of the device 200.

The top edges of the risers 107 may also be shaped, stepped or tiered to create complex gap configurations which can be used to adjust the magnetic and electrical properties of each inductor (or the device as a whole) including, e.g., energy storage in each leg 106 and flux density across each leg/cap interface. This also can affect the geometry and requirements of the central element 108, whose cross-sectional area for example is dictated at least in part by the geometry of the leg/cap interfaces.

As described above, the windings 120 (and the device 200 as a whole) of the illustrated embodiment are self-leaded. In this context, the term “self-leaded” refers to the fact that separate component terminals electrically connecting the windings 120 to corresponding pads on the PCB or parent device, are not needed. One advantage of having self-leaded windings is to minimize the component count and complexity of the device 100, as well as increasing its reliability. When the assembled device 200 is disposed on the parent device (e.g., PCB), the contact pads of the windings 120 are situated proximate to the PCB contacts pads, thereby facilitating direct bonding thereto (such as via a solder process). This feature obviates not only structures within the device 200, but also additional steps during placement on the PCB.

In yet another alternative embodiment, the free ends of the windings 120 are received within apertures (not shown) formed in the PCB or other parent device when the inductor device 200 is mated thereto. The free ends are disposed at 90 degrees (right angle) to the plane of the core, such that they point downward (normal to the surface to which the device will be attached) in order to permit insertion into slots formed in the PCB. Alternatively, the windings 120 can be deformed around the legs 106 in somewhat of a dog-leg shape (when viewed from the side of the winding), thereby allowing for the aforementioned insertion, as well as providing a more firm coupling between the core leg 106 and the relevant winding 120 (since the winding wraps under each leg somewhat before projecting normally toward the surface of the PCB).

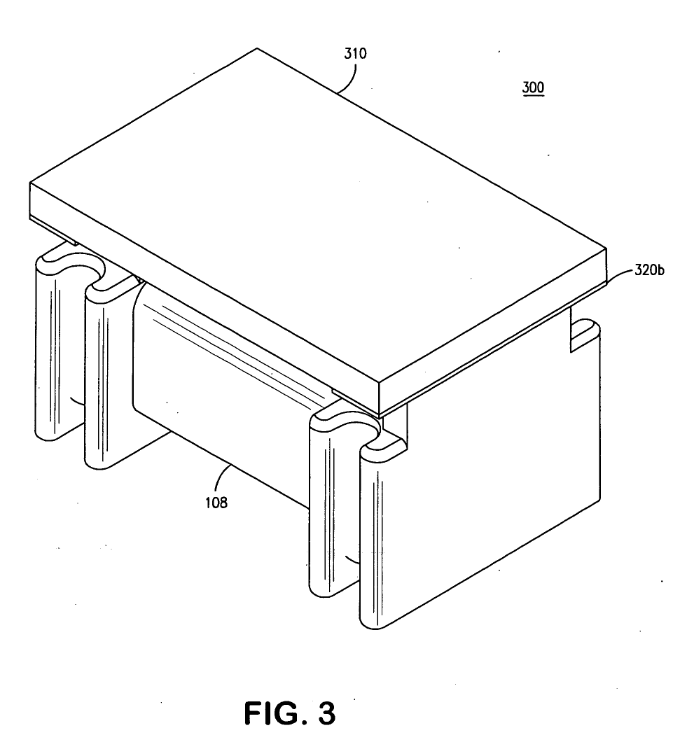

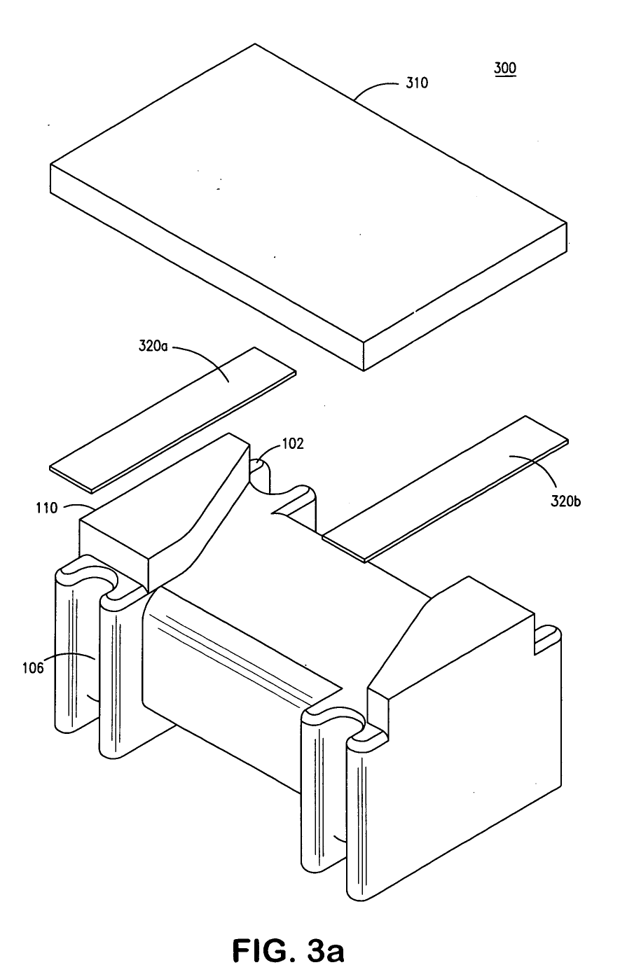

Referring now to FIG. 3, yet another alternate embodiment of an inductive device 300 according to the invention is shown. In this embodiment, the cap element 310 is characterized as a single gapless and substantially planar magnetically permeable element. The bottom surface of cap element 310 is separated from the top surface 104 of core element 110 by spacer elements 320. The pair of spacer elements 320a, 320b is preferably made of a dielectric material such as e.g. a Kapton® (polyimide) layer or the like interposed between the core 110 and cap element 310. These spacer elements 320a, 320b form a gap between core element 110 and cap core element 310. The thickness of these spacer elements 320 may thus be varied in order to obtain the desired electrical/magnetic properties.

In addition, and as is perhaps best seen in FIG. 3a, the spacer elements 320a and 320b are shaped to accommodate the peripheral profile of cap element 310. In alternate embodiments, these spacer elements 320 may be shaped to accommodate the profile of the top surface 104 of core element 110, or some variant profile in-between the two surfaces.

The devices shown in FIGS. 1-3a may also be externally shielded if desired using any one of myriad well-known shielding technologies available in the art (such as tin plating or use of a wrap-around Faraday shield).

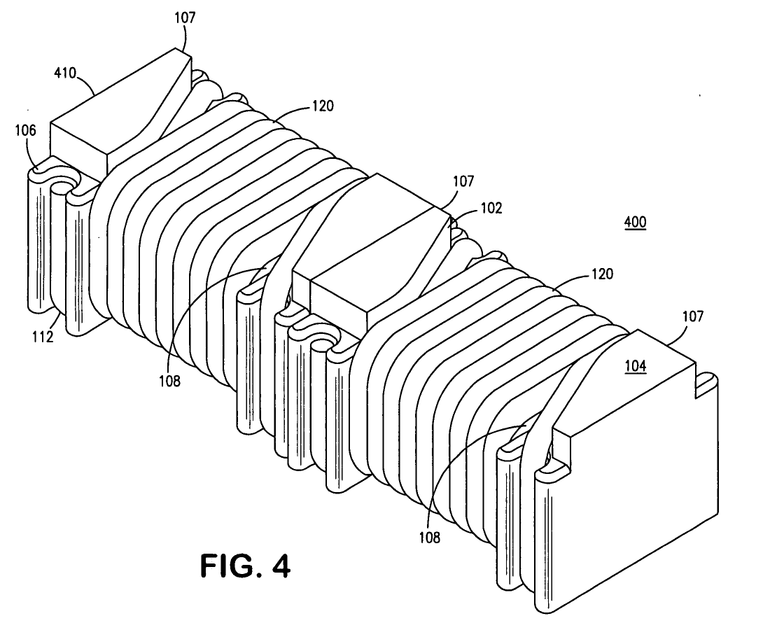

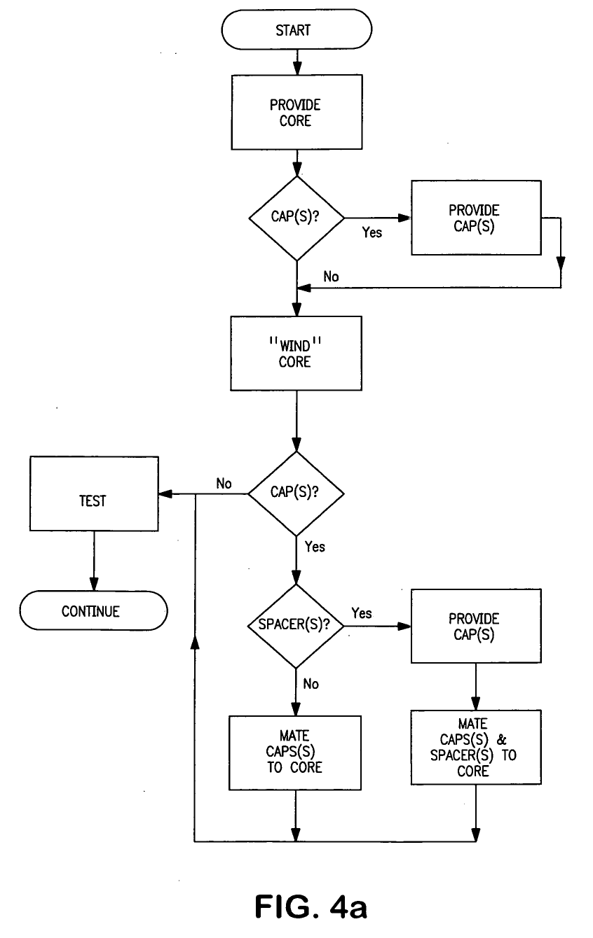

Referring now to FIG. 4, an exemplary embodiment of a dual self-leaded inductive device 400 is described in detail. FIG. 4 shows an illustrative embodiment of a dual inductive device 400 comprising a “common” or unitary core inductor 410. The inductive device 400 generally, comprises a device core 410 comprising a plurality of legs 106, a plurality of mating surfaces 104 and a pair of central spindle elements 108. The mating surfaces 104 generally comprises a substantially planar top face, which can be adapted for use with pick-and-place equipment, a magnetically permeable cap core (such as item 210 shown in FIG. 2) or alternatively might not be utilized at all. In addition the height, cross-sectional area, and profile of the central spindle elements 108 can be adjusted as desired (discussed in greater detail below) in order to provide the desired electrical properties of the device 400.

The core 410 is, in the illustrated embodiment, either formed directly (e.g. via sintering methods) as shown or alternatively machined from a block to have the desired features. Using the latter approach, either alone or in combination with the first approach, a common block can be used as the basis for multiple different designs having varying shapes and associated electrical properties, and no special (expensive) additional tooling would be required. For example, where a device is designed to have a first cross-sectional area about the spindle elements 108, material can be machined off via well known techniques (milling or grinding) to define a new cross-sectional area. Notwithstanding the foregoing, it will be appreciated that the core of the present invention can feasibly be made to have any number of varying geometries, etc. consistent with the original design.

Additionally, not only can the size of the center spindle elements 108 be varied depending on the operation of the inductive device (whether in a homogenous or heterogeneous matter from spindle element 108 to spindle element 108), the center spindle elements 108 can also have a different cross-sectional shape (whether uniform or non-uniform in cross-sectional area over the length of the spindle element 108), such as for example circular, elliptical, hexagonal, triangular, etc. In this way, each inductive device 400 can be specifically adapted for its intended application.

The illustrated core 410 may comprise a unitary (i.e., one piece) structure, or alternatively may comprise two or more individual pieces mated or bonded together. A dielectric may also be interposed between the two pieces if desired, effectively controlling the magnetic interaction between the two sides (i.e., one physical assembly, yet two substantially discrete devices).

Moreover, the device of FIG. 4 can utilize one or more cap elements of the type previously described with respect to FIGS. 2a-3a herein (e.g., a one-piece or multi-piece cap).

A plurality of windings 120 are disposed on each of the spindle elements 108. Each end winding of the plurality of windings 120 is disposed in their respective channel 112 of each leg 106 in a wrap-around fashion, such that at least a portion of the windings 120 is disposed proximate to the underside of the device core 110. This approach advantageously allows for self-leading, described below, wherein the bottom portion of the windings 120 comprise, inter alia, mounting points for electrically connecting the device 400 to a parent PCB. As such, the pads 120 may be electrically connected to the parent PCB in any number of ways well known in the art (e.g. solder joints, direct forced physical contact, adhesives, bonding, etc.).

In one embodiment, the magnetically permeable material utilized for the device core 410 will comprise a Ni—Zn material. Ni—Zn is known for its good resistive properties allowing for self leaded terminations of the windings 120. Furthermore, different types of pad and winding structures may be used with the device as is well known in the electronic arts, including without limitation terminal pins, balls, and surface mount (i.e., “Gull wing” shaped) leads. The windings 120 (and hence the pads, which are merely part of the windings 120) are made of electrically conductive materials (e.g., copper or copper alloys), although other materials may be used.

It will further be recognized that the windings 120 and conductive pads may be actually formed onto the core 410 itself, such as for example where the windings are coated or plated onto the surface of the core 410 (not shown), such as within the recesses 112 formed within the legs 106. The conductive windings 120 can also feasibly be sprayed on as well, i.e., as a thin layer of conductive material on the surface of the core 410. Myriad other approaches to providing conductive traces on one or more surfaces of the core 102 may be used consistent with the invention, all such variants being readily implemented by those of ordinary skill provided the present disclosure.

Each leg 106 of the exemplary embodiment will also advantageously comprise a lead-in channel 102 that guides the end of the winding 120 into the leg channel 112. This lead-in channel 102 will facilitate the automation of the winding placement by automated winding equipment. Further, shielding (not shown) may encase the outside of the device 400 in order to prevent unwanted electromagnetic radiation, whether on to or off of the device 400.

Referring now to FIG. 4a, one exemplary embodiment of the method of manufacturing the self-leaded device(s) of FIG. 1-4 is now described.

In a first step 452, a shaped core 102 of the type previously described is provided. This may also include providing additional core or cap elements 210, 210a, 210b, 310 as shown in FIGS. 2, 2a and 3, respectively.

The primary core element 102 is then wound with one or more windings 120 as previously described, per step 454. This winding step may comprise physically winding a wire or other conductor around the core 102, or alternatively forming or depositing the windings, such as via a spray, dip, plating, or other deposition process of the type well known in the art.

Next, per step 456, the spacer elements 310 (e.g., Kapton or other material as previously discussed) are optionally provided; i.e., in embodiments such as that of FIG. 3.

Per step 458, the one or more cap elements 210, 310 as applicable are then mated to the wound core 102, including using the spacer element 310 if required. The required gap tolerance is also set as required as part of this step 458.

### “Bead” Inductor Embodiments

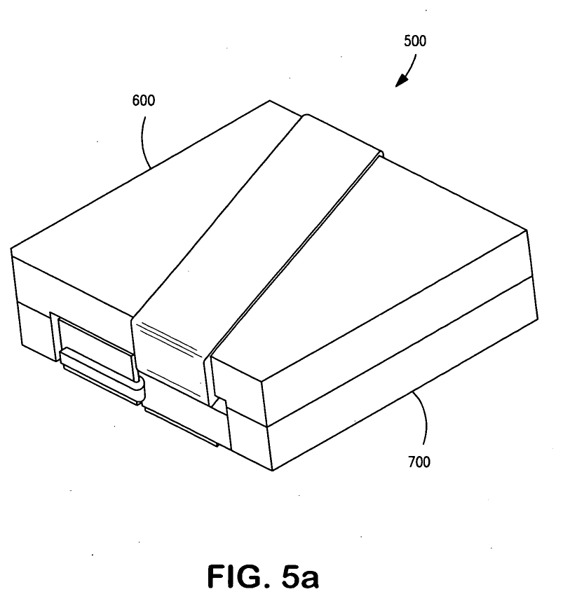

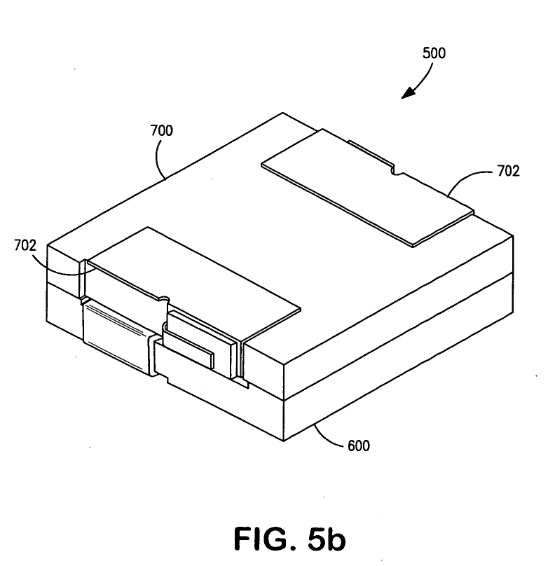

Referring now to FIG. 5a, a first embodiment of a bead inductor 500 according to the present invention is shown. In the present embodiment, the bead inductor 500 comprises two main assemblies: (1) A first core assembly 600; and (2) a second core assembly 700. In this embodiment, the first core assembly 600 generally comprises a magnetically permeable “C” core type element, while the second core assembly 700 generally comprises a magnetically permeable “I” core type element. The present embodiment bead inductor 500 is suitable for power applications, and has been proven to operate at inductance values from 0.3 to 0.6 uH, at a saturation current from 17 to 30 amps, although clearly other inductance, current and power levels may be supported. Saturation current is defined in the present context as the current level that reduces the initial inductance value by 10%. Other inductance values and saturation current levels are possible depending on factors well known in the electronic design arts (e.g. core permeability, cross-sectional areas, etc.) with the aforementioned values merely being exemplary of present configuration capabilities.

FIG. 5b shows the reverse perspective view of the bead inductor shown in FIG. 5a. As can be best seen in this view, the second core assembly comprises terminal clips comprising terminal pads 702 for connection to a parent device (not shown) via, e.g., well known soldering techniques.

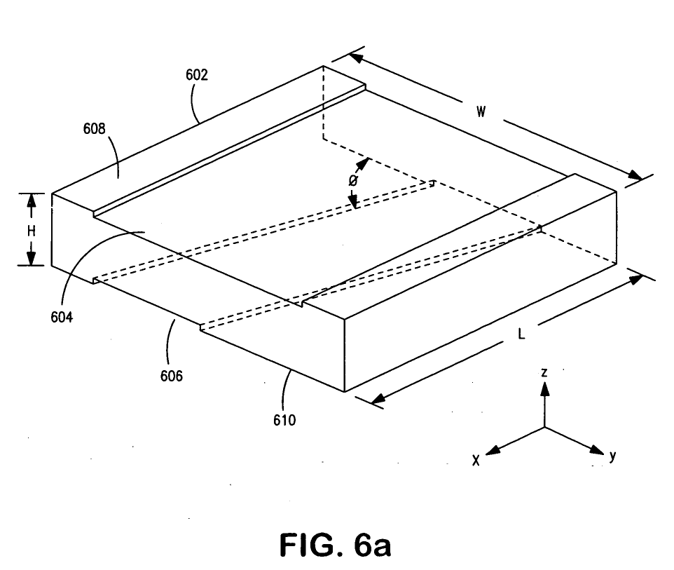

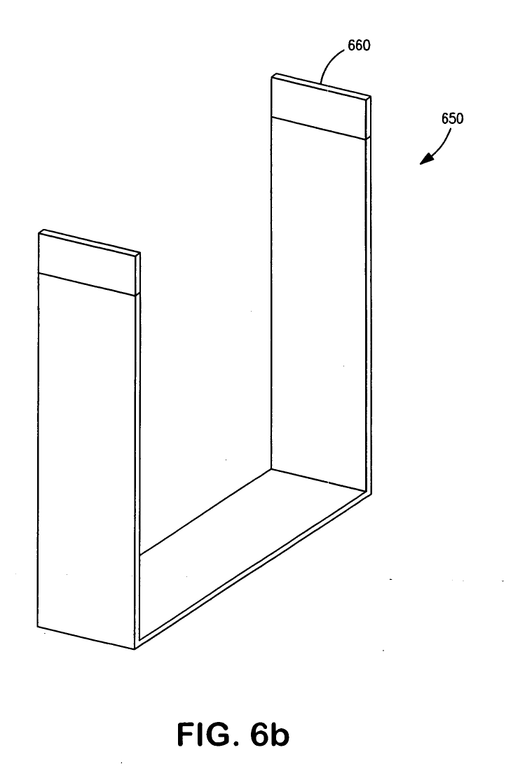

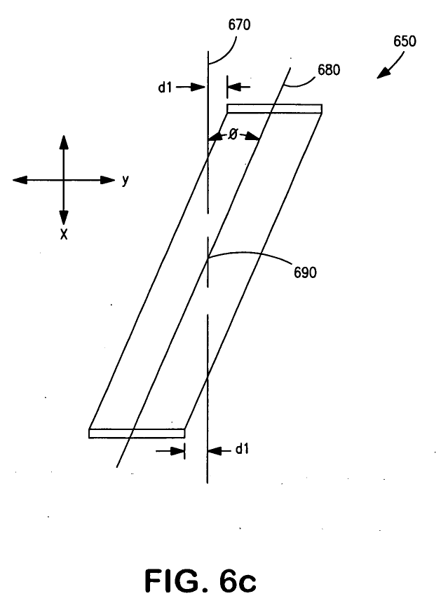

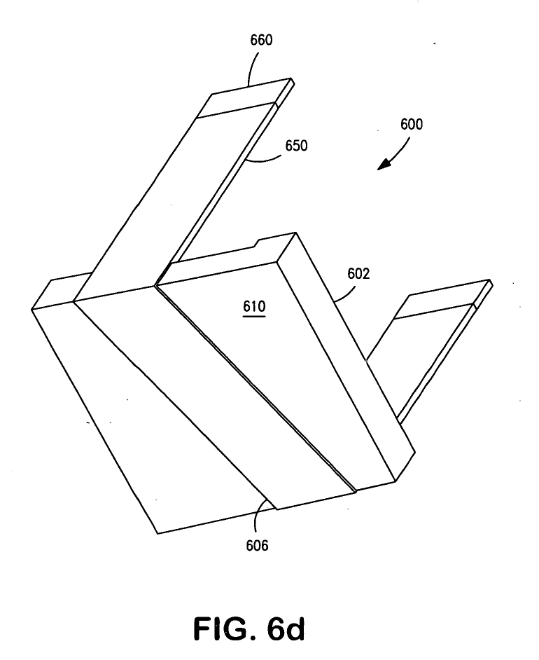

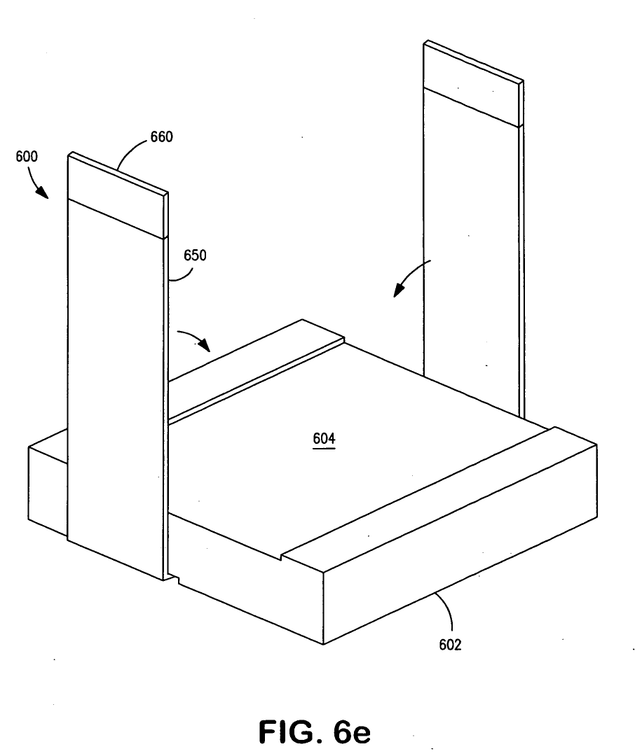

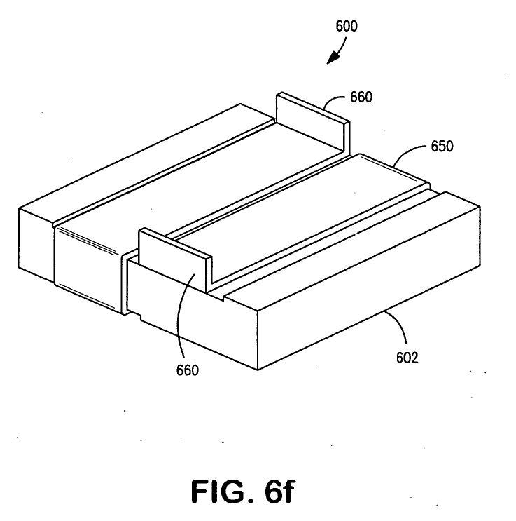

Referring now to FIG. 6a, the base core element 602 of the first core assembly 600 is shown and described in detail. Base core element 602 comprises a magnetically permeable material of a generally rectangular volume having a height “H”, a width “W” and a length “L”. In one embodiment, the magnetically permeable material comprises a ferrite based material having a permeability of about 2400, although other values may be used. The outside surfaces of the base core element 602 will advantageously comprise a thin (i.e., on the order of 15-50 microns) coating of a parylene which acts as, inter alia, an electrical barrier to the conductive terminals to be disposed adjacent the core material. The base core element 602 comprises a top surface 608 and a relief groove 604 adapted to accommodate the conductive winding(s) in the first core assembly 600. The relief groove 604 will have a depth approximately equal to the conductive terminal thickness.

The bottom surface 610 of the base core element 602 comprises a diagonally oriented groove 606 having an angle θ with respect to the Y-axis of FIG. 6a. The purpose and function of this angled groove 606 will be discussed more fully below with regards to FIGS. 6d-6f. In the present embodiment, this angle θ comprises an angle of 107 degrees, although other angles may be readily substituted consistent with the principles of the present invention. As will later be seen, angle θ will comprise a function of the base core element 602 length, width and diagonal groove 606 width, among other factors. The depth of diagonal groove 606 will, like top relief groove 604, typically be a function of conductive terminal thickness.

While primarily discussed with regards to a top and bottom surface, etc., the present invention is not so limited. These terms are merely used in the relative sense with regards to the presently demonstrated embodiment. These terms should merely be illustrative of the broader concepts.

Referring now to FIG. 6b, a first embodiment of a partially formed conductive terminal 650 is described in detail. The conductive terminal 650 comprises a generally U-shaped element prior to being installed on to the base core element 602. Each end of conductive terminal 650 further comprises solder tinned edges 660. The solder terminal will advantageously comprises a RoHS compliant solder, although tin-lead combinations may readily be used as well. Because of the construction of the bead inductor 500, the design is easily adaptable to accommodate the higher temperatures needed in many RoHS compliant applications. The base material of the conductive terminal 650 will advantageously comprise a copper or copper based alloy although other materials well known throughout the electronics industry may readily be substituted depending on the intended application. The base material may optionally be plated with nickel or another common plating material to provide corrosion resistance, as well as other advantageous properties to the conductive terminal 650. In some embodiments, it may also be desirable to coat the conductive terminal with an epoxy or parylene coating on selected segments in order to improve the isolation properties of the terminal.

As perhaps is best seen in FIG. 6c, the conductive terminal will also comprise an angled bend with respect to the X and Y directional axes. Centerline axes 670 and 680 will comprise an angle φ that will be compatible with angle θ shown on the base core element 602 of FIG. 6a. In this embodiment, angle φ will approximately equal 90 degrees minus angle θ in order to fit within diagonal groove 606. Here, distance d₁ defines the distance between the edges of the conductive terminal 650 and the centerline 670. As can be seen, the angles φ and θ are chosen so that distance d1 equals a desired distance (thus preventing the ends of conductive terminal 650 from overlapping when formed). As can be seen in FIG. 6d, the conductive terminal 650 will fit within diagonal groove 606 of base core element 602 such that the top surface of conductive terminal 650 is approximately level with the top surface 610 of core element 602.

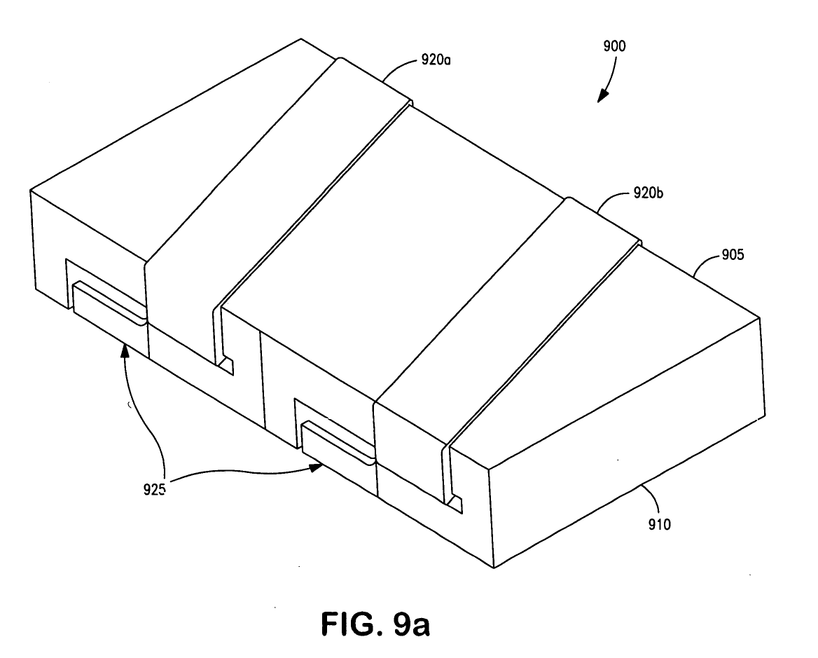

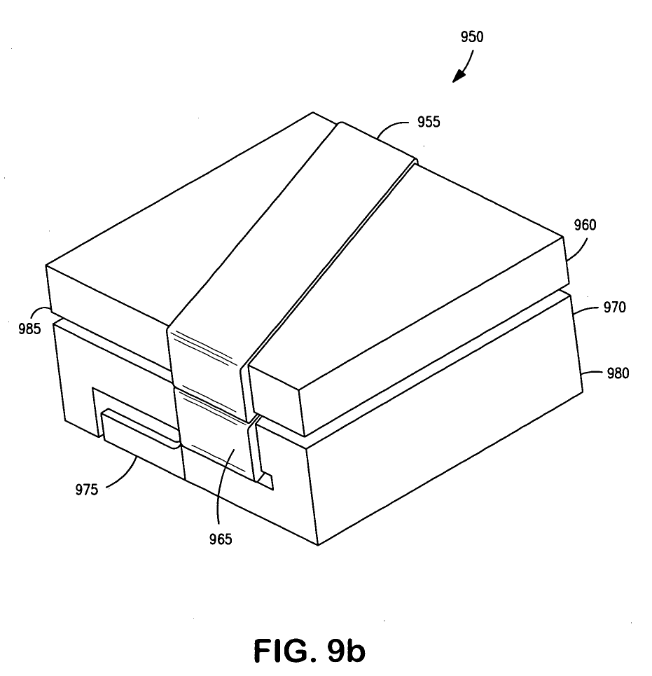

Referring now to FIGS. 6e-6f, the conductive terminal 650 is then formed into relief cavity 604 of core element 602 to provide the two turns needed on the bead inductor device 500. After forming the conductive terminals 650 into relief cavity 604, the tinned ends 660 of the conductive terminal 650 are bent upward at an approximate 90° angle with respect to relief cavity surface 604. The order of these bends may be readily modified in order to obtain the first core assembly 600 shown in FIG. 6f. Further, while shown as a two-turn device presently, the concepts of the present invention may readily be adapted for three or more turns. Exemplary embodiments with more turns are discussed more fully with respect to FIGS. 9a-9b below.

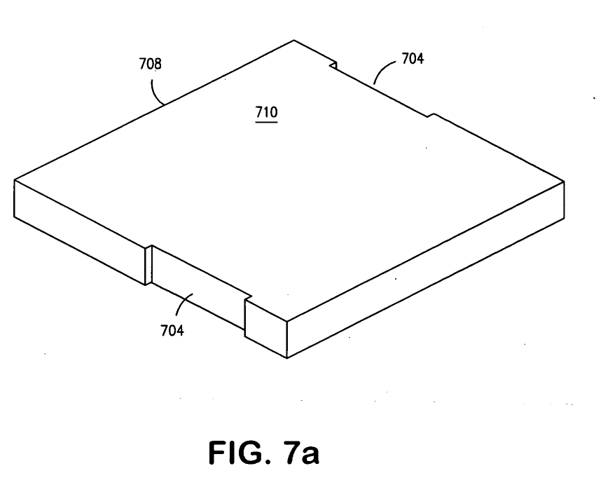

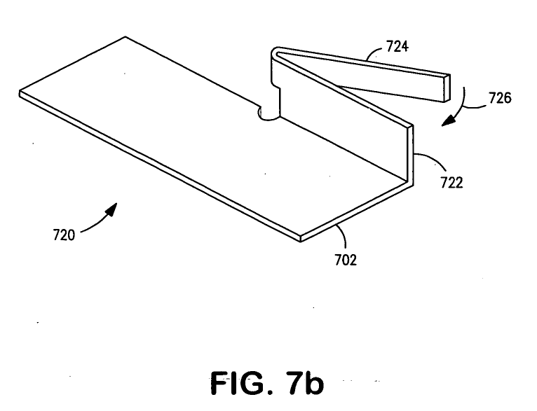

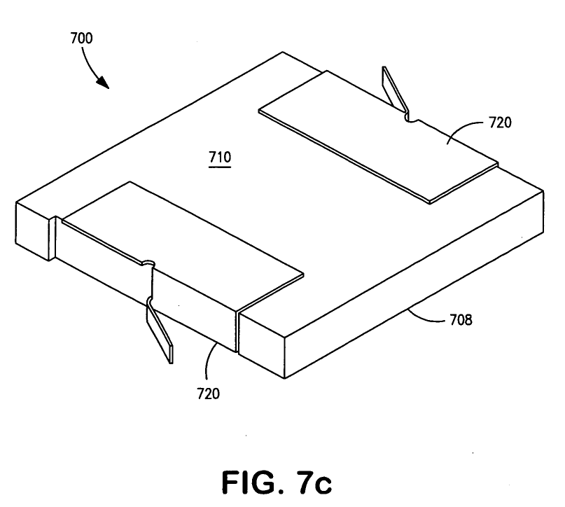

Referring now to FIG. 7a, a first embodiment of the cap core element 708 is shown. In one embodiment, the cap core element 708 comprises a similarly magnetically permeable material as that used in the base core element 602, albeit it may be desirable that the properties be different in certain applications. The cap core element 708 comprises a plurality of clip mounting slots 704 and a bottom surface 710 which are adjacent the parent device when the bead inductor 500 is ultimately mounted to the parent device.

FIG. 7b shows a first embodiment of a termination clip 720 adapted for mounting on the cap core element 708 shown in FIG. 7a. The termination clip 720 comprises a terminal end 702 adapted for mounting to a parent device as well as the bottom surface 710 of cap core element 708. The termination clip 720 further comprises a conductive winding clip 722, 724 with the arm 724 adapted to move in a lateral direction 726 in order to engage the conductive winding 650. Note that the present embodiment minimizes material usage of the clip 720 (i.e. raw material) while providing more surface contact via two surfaces 722, 724 for engaging the conductive winding 650 thus maximizing the cost effectiveness of the design. FIG. 7c shows two (2) termination clips 720 mounted to the bottom surface 710 of cap core element 708 thus forming the second core assembly 700.

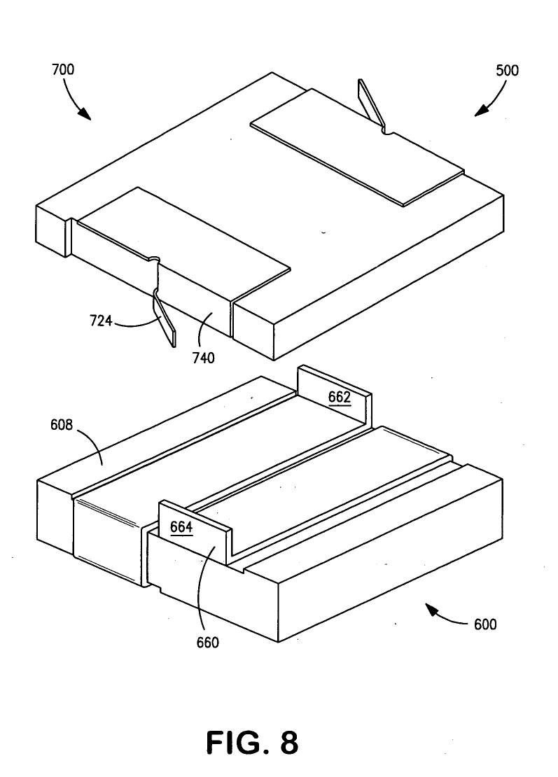

Referring now to FIG. 8, the assembly of the first core assembly 600 to the second core assembly 700 is demonstrated. When second core assembly 700 is mounted onto the top surface 608 of the first core assembly 600, the inside surfaces 662 of solder tinned edges 660 lies proximate the outside edge 740 of the termination clip 720. The arm 724 is then bent inward to engage the outside surface 664 of the solder tinned edges 660 of the conductive winding 650. Standard connection techniques (e.g. soldering, resistive welding, conductive epoxies, etc.) may then be used to put the second core assembly 700 in electrical connection with the first core assembly 600.

While FIGS. 5a-8 demonstrate a single two-turn bead inductor design, the principles of the present invention may be readily be adapted to alternative designs. For instance, FIG. 9a shows an embodiment incorporating two (2) two-turn bead inductors into a single device 900. The device 900 comprises a first core assembly 905 having conductive windings 920a, 920b. The second core assembly 910 comprises four (4) termination clips 925. Alternatively, the two conductive windings 920a, 920b may be in electrical contact with one another thus forming a single four-turn device (not shown).

Referring now to FIG. 9b, it can be readily seen that the principles of the present invention can be incorporated into a device 950 comprising more than two (2) turns of a conductive element (here 955 and 965), e.g. stacked in a vertical (as opposed to horizontal) configuration. In the present embodiment, three distinct core element assemblies 960, 970 and 980 are utilized. The first core assembly 960 comprises a first conductive element 955. The second core assembly 970 comprises a second conductive element 965 and the third core assembly 980 comprises two termination clips 975. A dielectric barrier (such as e.g. Kapton or an epoxy, etc.) may optionally be utilized to electrically isolate conductive element 955 from conductive element 965 to produce the desired electrical characteristics of the device 950.

While FIGS. 9a and 9b have demonstrated designs either containing more than a single two-turn inductor or designs incorporating three or more turns onto a single bead inductor, these principles may readily be implemented into alternative embodiments. For instance, one could implement a dual three- or four-turn inductive device. Alternatively, one could implement a five- or six-turn inductor, etc. by stacking core elements. All of these embodiments would be readily produced by one of ordinary skill given the present disclosure.

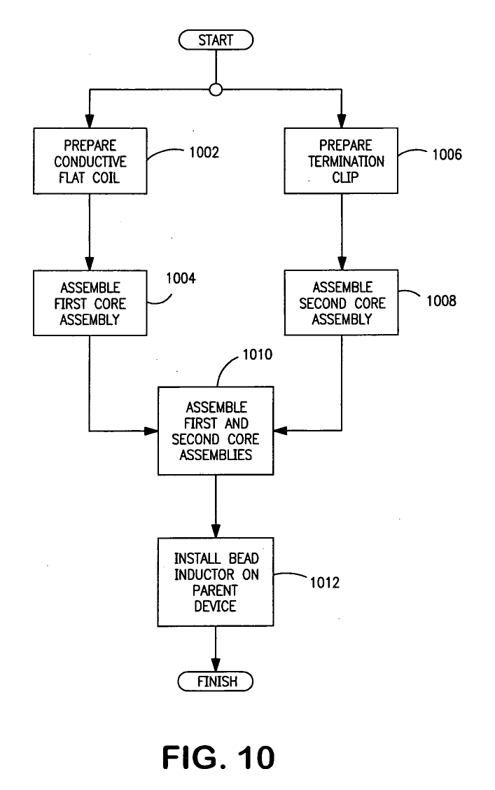

Referring now to FIG. 10, one exemplary method for manufacturing the bead inductive device 500 of FIGS. 5a and 5b is described in detail.

At step 1002, the conductive terminal 650 is prepared. The conductive terminal 650 is first pre-cut to a specified overall dimension suitable for the final design. These pre-cut conductive terminals 650 can be optionally mounted on a carrier to facilitate the production of the conductive terminal 650 on progressive stamping equipment. After the overall dimension of the terminal 650 has been formed, the coils are then formed into the diagonal S-Bend shape suitable for fitting into the diagonal relief cut 606 of core element 602.

Next, the two free ends of the terminal 650 are solder dipped with a preferably RoHS compliant solder. The depth of these solder dip operations may vary but will generally comprise a depth of approximately 1.5 mm. In the final processing step of step 1002, the two sides are bent at approximately 90 degrees (see e.g. FIG. 6b).

Next in step 1004, the partially formed conductive terminal 650 is assembled onto core element 602 as perhaps is best seen in FIG. 6d. The protruding ends of the conductive terminal 650 are then formed down onto the core element 602 and the solder dipped ends bent upward at a 90 degree angle as is best seen in FIG. 6f.

At step 1006, the termination clips 720 are formed into the shape as best seen in FIG. 7b. As can be seen from this drawing, the termination clips start as a rectangular flat sheet. The flat coil termination end 722 is then partially separated from the parent device terminating end 702. The flat coil termination end 722 is bent upwards at a 90° angle, and the flat coil engaging end 724 is formed at an acute angle. As is well understood in the metal stamping arts, these termination clips 720 could readily be formed using standard progressive stamping equipment for low cost and repeatability.

At step 1008, the termination clips 720 are assembled onto the cap core element 708 as best shown in FIG. 7c. The termination clips 720 are secured to the core 708 using an epoxy adhesive and then cured to secure the bond of the second core assembly 700.

At step 1010, the first core assembly 600 is assembled with the second core assembly 700 as best shown in FIG. 8. The tinned ends 660 of conductive terminal 650 will engage the termination clips 720 of the second core assembly 700. As previously discussed, the inside edges 662 of conductive terminal 650 will engage the outside edge 740 of the termination clip 720. Arm 724 is then bent inward to engage the outside surface 664 of the solder tinned edges 660 of the conductive winding 650. Standard connection techniques (e.g. soldering, resistive welding, conductive epoxies, etc.) may then be used to put the second core assembly 700 in electrical connection with the first core assembly 600.

At step 1012, the bead inductor device 500 is installed on a parent device to form an assembly (and at least a portion of an electrical circuit). Because the top surface of bead inductor 500 is substantially flat, pick and place equipment may be utilized if the bead inductor is disposed in appropriate packaging (e.g. an EIA compliant tape and reel carrier). The device 500 will then be subjected to an IR reflow process or other comparable processing technique to terminate the device 500 to the parent device.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1.-29. (canceled)

30. A multiple turn inductive device, comprising:
a conductive winding comprising a plurality of turns; and
a plurality of substantially rectangular core elements;
wherein at least one of said plurality of core elements comprises a diagonal recess, thereby allowing said conductive winding to comprise multiple turns.

31. The multiple turn inductive device of claim 30, wherein said conductive winding comprises a substantially rectangular cross-sectional profile.

32. The multiple turn inductive device of claim 31, wherein said conductive winding comprises a predetermined thickness, said predetermined thickness permitting said conductive winding to be formed into a substantially rigid shape.

33. The multiple turn inductive device of claim 32, wherein said conductive winding further comprises a plurality of soldered edges.

34. The multiple turn inductive device of claim 33, wherein individual ones of said plurality of soldered edges comprise an RoHS (Reduction of Hazardous Substances) compliant soldered edge.

35. The multiple turn inductive device of claim 33, further comprising a plurality of terminal clips, said plurality of terminal clips each adapted to interface with respective ones of said plurality of soldered edges.

36. The multiple turn inductive device of claim 30, wherein said at least one of said plurality of core elements comprising a diagonal recess further comprises a substantially rectangular recess, said substantially rectangular recess disposed on an opposing surface to a surface comprising said diagonal recess.

37. The multiple turn inductive device of claim 36, wherein a second one of said plurality of core elements comprises one or more recesses on at least one side surface of said second one of said plurality of core elements;
wherein said at least one side surface is orthogonal to said surface comprising said diagonal recess.

38. The multiple turn inductive device of claim 37, further comprising one or more terminal clips, said one or more terminal clips each adapted to mechanically interface with respective ones of said one or more recesses on at least one side surface of said second one of said plurality of core elements.

39. The multiple turn inductive device of claim 38, wherein at least one of said one or more terminal clips comprises:
a substantially planar surface; and
a clip feature element comprising a first surface and a second surface, said first surface and said second surface adapted so as to permit the insertion of at least a portion of said conductive winding therebetween.

40. The multiple turn inductive device of claim 30, wherein said diagonal recess has a depth generally corresponding to a thickness of said conductive winding thereby permitting the surface comprising said diagonal recess to be substantially coplanar when said conductive winding is inserted into said diagonal recess.

41. A multiple turn inductive device, comprising:
a conductive winding comprising a plurality of turns and a plurality of solderable edges;
a plurality of termination clips; and
a plurality of substantially rectangular core elements;
wherein at least one of said plurality of core elements comprises a recess, thereby allowing said conductive winding to comprise multiple turns.

42. The multiple turn inductive device of claim 41, wherein at least a first portion of individual ones of said plurality of termination clips is adapted to interface with respective ones of said plurality of solderable edges; and
wherein at least a second portion of individual ones of said plurality of termination clips is adapted to interface with an external substrate.

43. The multiple turn inductive device of claim 42, wherein said first portion comprises a conductive winding clip, said conductive winding clip adapted to interface with individual ones of said plurality of solderable edges on at least two surfaces of said solderable edge.

44. The multiple turn inductive device of claim 43, wherein said plurality of termination clips are shaped so as to form a substantially rectangular profile when in a flattened state, said substantially rectangular profile mitigating waste associated with the manufacture of said plurality of termination clips.

45. A method of manufacturing a multiple turn inductive device, comprising:
forming a conductive winding comprising a substantially flat profile;
forming a plurality of substantially rectangular core elements, at least one of said plurality of core elements comprising a diagonal recess;
forming a plurality of termination clips; and
combining said conductive winding, said plurality of substantially rectangular core elements and said plurality of termination clips to manufacture said multiple turn inductive device.

46. The method of claim 45, further comprising soldering a plurality of edges of said conductive winding.

47. The method of claim 46, wherein said at least one of said plurality of core elements comprising a diagonal recess further comprises a substantially rectangular recess, said substantially rectangular recess disposed on an opposing surface to a surface comprising said diagonal recess.

48. The method of claim 45, wherein each of said termination clips is formed according to the method comprising:
forming a substantially planar surface; and
forming a clip feature element comprising a first surface and a second surface, said first surface and said second surface adapted so as to permit the insertion of at least a portion of said conductive winding therebetween.

49. The method of claim 45, further comprising:
inserting said conductive winding into said diagonal recess;
wherein said diagonal recess has a depth generally corresponding to a thickness of said conductive winding thereby permitting the surface comprising said diagonal recess and said inserted conductive winding to be substantially coplanar.
